(19) United States
(12) Patent Application Publication
(10) Pub. No.: US 2006/0025993 A1
(43) Pub. Date: Feb. 2, 2006

(54) Audio processing

(75) Inventors: Ronaldus Maria Aarts, Eindhoven (NL); Daniel Willem Elisabeth Schobben, Eindhoven (NL); Faizal Sheik Soeltan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, BA Eindhoven (NL)

(21) Appl. No.: 10/520,201

(22) PCT Filed: Jun. 18, 2003
(86) PCT No.: PCT/IB03/02747

§ 371 Date: Jan. 4, 2005

(30) Foreign Application Priority Data
Jul. 8, 2002 (EP) 02077728.0

(51) Int. Cl. G10L 21/00

(52) U.S. Cl. 704/228

(57) ABSTRACT

An audio system comprises a post-processor (12) arranged to alter successive fragments of a decoded audio signal (14) to provide successive fragments of post-processed audio signal (16). A masking threshold generator (20) provides an estimate of a masking threshold ( ) for successive fragments of post-processed audio signal (16). A noise level generator (17) provides an estimate of a noise level ( ) for successive fragments of the post-processed audio signal (16). A distortion generator (17) determines a degree (D) to which the noise level exceeds the masking threshold for successive fragments of the post-processed audio signal (16). A regulator (18) controls the post-processor according to the degree to which the noise levels exceed the masking threshold.

The present invention relates to processing audio signals.

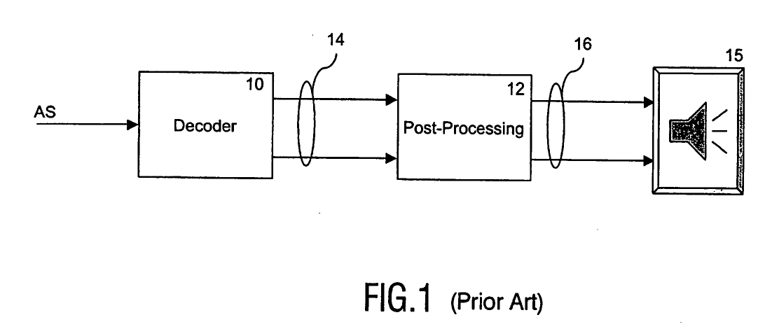

Referring now to FIG. 1, in a conventional audio system, a decoder 10 receives an audio stream AS in which an audio signal (not shown) has been encoded. The decoder 10 produces time-domain signals 14 corresponding to successive fragments of the audio signal. For a stereo-encoded audio signal, the decoder produces a pair of, for example, mid/side or difference stereo-channel signals 14. It is known to apply post-processing to these channel signals to enhance aspects of the signal. So, for example, a post-processor 12 may perform stereo widening on the channel signals 14 to produce altered channel signals 16. The channel signals 16 are then fed to an audio output system 15 through which the signals are played for a listener, or alternatively stored or transmitted.

In many encoders, including for example MPEG encoders, an audio signal is encoded in a bit stream using a lossy process. It has been found that cascading audio decoders (codecs) for such bit streams and post-processing components can be problematic. This is because post-processing a lossy encoded audio fragment can result in unwanted audible artefacts due to quantization noise generated in encoding the original audio fragment.

To prevent degraded audio quality of encoded fragments after post-processing, the encoder, the decoder or the post-processor could be modified. However, this would involve significant re-engineering of existing systems.

Because a solution to the above problem needs to be implemented in systems that apply post-processing to already encoded fragments, it should be noted that the original audio fragment from which the bitstream was produced would generally not be available.

At the same time, before any post-processing changes to a signal are made, the quality of the audio signal after post-processing should be known. Although some techniques can be found in the literature for objective audio quality measurement, they generally assume that the original audio fragment is available.

Conventional methods, such as cross-correlation don't indicate whether quantization noise will be audible or not. Simple experiments have shown that the cross-correlation between left and right channels for post-processed mid/side-encoded and difference-encoded stereo fragments are similar, whereas the audio-quality of the post-processed fragments of both modes can be completely different.

According to the present invention there is provided an audio system according to claim 1.

The present invention provides a system and method for detecting audible quantization noise after post-processing without having an original audio fragment available and preventing quantization noise becoming audible by adjusting the degree of post-processing.

The invention provides a “blind” objective measurement of a signal i.e. quality measurement is performed with only the decoded audio fragment available. The invention makes changes in the signal path in a manner that means existing components do not need to be modified to implement the invention.

Embodiments of the present invention will now be described by way of example with reference to the accompanying drawings, in which:

FIG. 1 shows a prior art audio system;

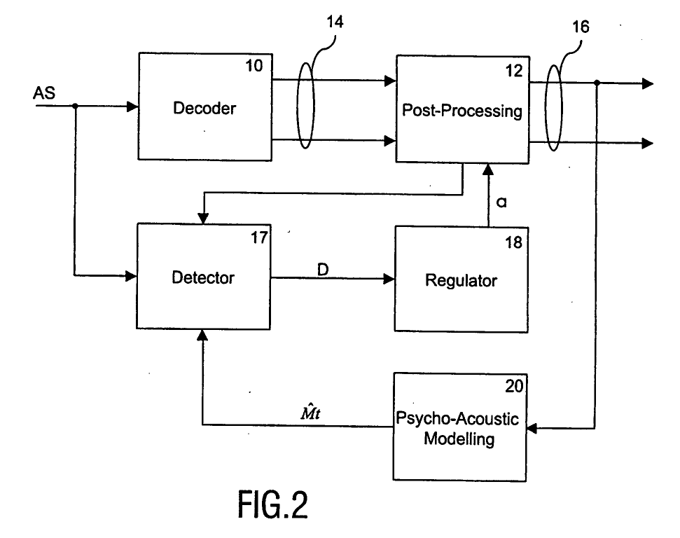

FIG. 2 shows an audio system according to a first embodiment of the present invention;

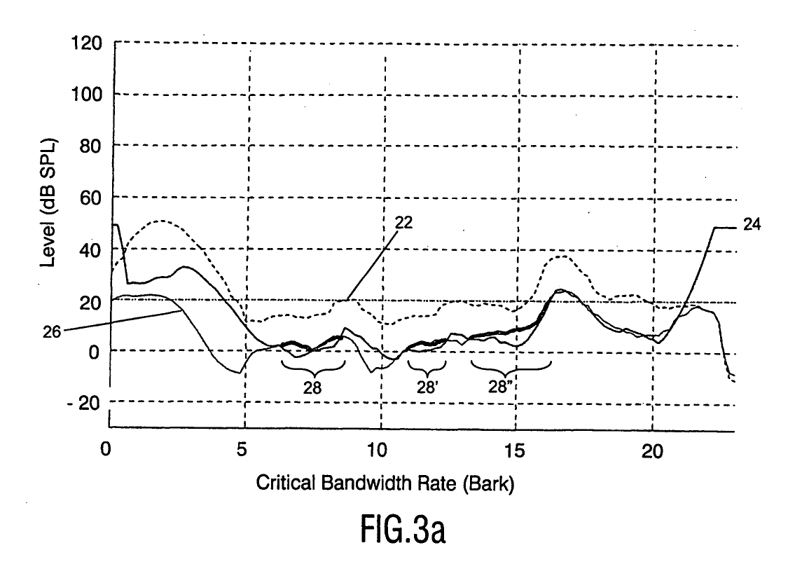

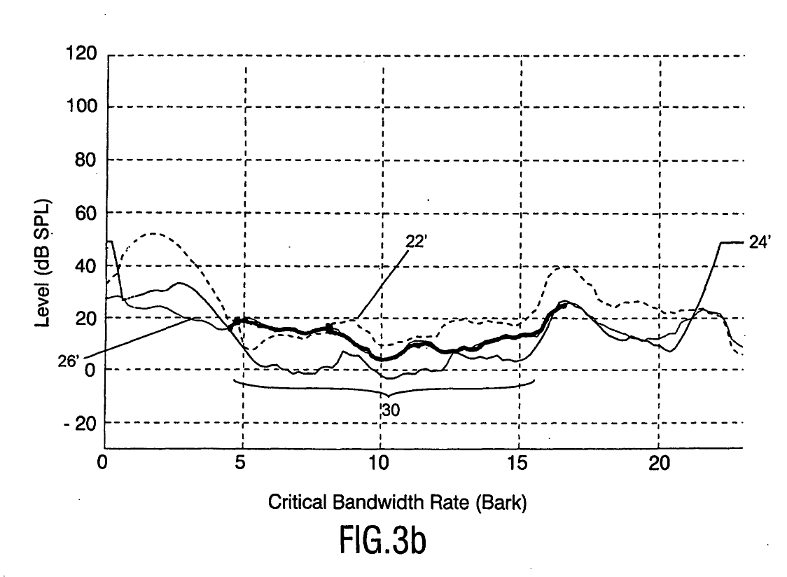

FIGS. 3(a) and (b) illustrate the degree of quantization noise audible for an original signal and a post-processed signal respectively; and

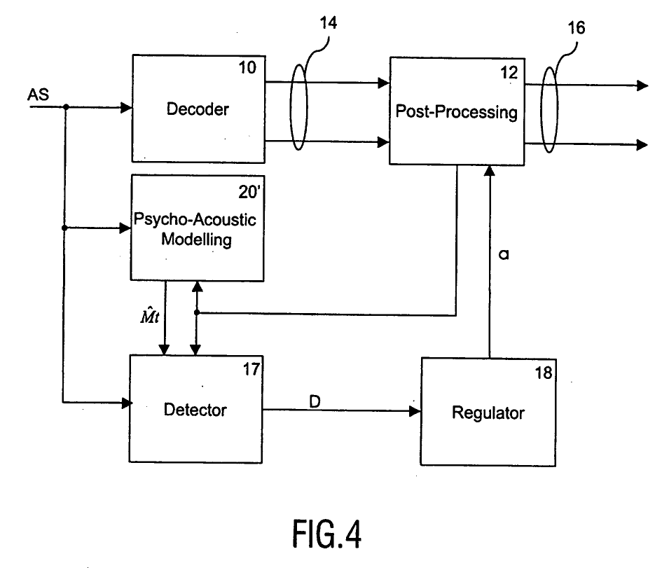

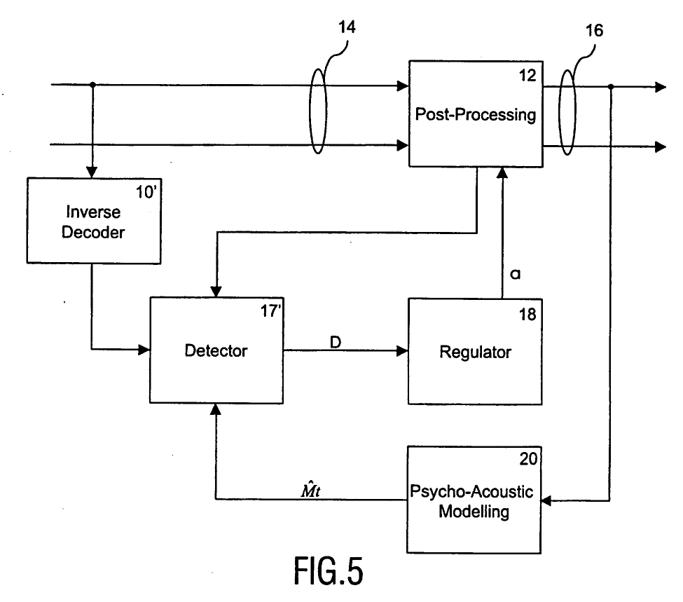

FIG. 4 and 5 illustrate further audio systems according to alternative embodiments of the present invention.

FIG. 2 shows an audio system for post-processing encoded audio fragments according to a first embodiment of the present invention. First, an encoded audio bit-stream AS is decoded in a decoder 10 and afterwards post-processed by a post-processor 12. The preferred embodiment is described with reference to an MPEG-1 Layer I decoder in combination with an Incredible Sound post-processor (described in for example PCT Application No. WO98/21915 and U.S. Pat. No. 5,742,687) although it will be seen that the invention is applicable to encoders and post-processors in general. Thus, the decoder 10 produces a pair of output channels 14 in, for example, sum/difference or mid/side PCM (Pulse Code Modulated) form and the post-processor 12 performs stereo-widening on the channels 14 to produce output channels 16.

A detector 17 calculates an amount of distortion D for each frame or fragment of the audio stream and feeds this measurement to a regulator 18, which determines the maximum amount of post-processing permitted. In the case of Incredible Sound, the degree of stereo-widening performed by the post-processor 12 is determined by a parameter a provided by the regulator 18. Thus, the amount of post-processing can be decreased, if necessary, by the regulator 18 lowering the value of a supplied to the post-processing unit 12.

In the first embodiment, the audibility of quantization noise or the degree of distortion after post-processing is detected assuming that only the bit-stream for the coded fragment is available. The detection method is based on a psycho-acoustic model and the bit-allocation procedure used in an encoder during the bit-allocation process.

A psycho-acoustic model is based on the knowledge that due to the specific behavior of the inner ear, the human auditory system perceives only a small part of the complex audio spectrum. Only those parts of the spectrum located above a masking threshold of a given sound contribute to its perception. Thus, any acoustic action occurring at the same time as a given sound but with less intensity and thus situated under the masking threshold will not be heard because it is masked by the main sound event. The aim of an encoder is to lower the bit-rate of the audio stream as much as possible while keeping the quantization noise below the masking threshold.

In an MPEG encoder, the perceptible part of the audio signal is extracted by splitting the frequency spectrum into 32 equally-spaced sub-bands. In each sub-band, the signal is quantized in such a way that the quantizing noise matches or is just below the masking threshold.

However, after post-processing, the noise levels may exceed the masked threshold resulting in audible quantization noise. Thus, the detection method of the preferred embodiment determines to what extent the noise levels exceed the masked threshold.

In the first embodiment, the following assumptions are made:
the original audio signal fragment is not available,
the bit-stream of the coded fragment (AS) for the audio signal is available,
the type of post-processing technique used is known, and the coded fragment is perceptually equal, i.e. it should sound the same, as the original fragment.

Because the original fragment is not available, the actual error-signal (noise) resulting from quantization (the coded fragment minus the original fragment) is also not available. However, from a bitstream, information can be extracted to determine, for example, what type of codec, bit-rate(s) and settings have been used in the encoder to generate the bitstream.

Although it is assumed that the original fragment is not available in the preferred embodiment, the original fragment is useful in demonstrating the quality of the estimations employed in the preferred embodiments. So, referring to FIG. 3(a), the frequency spectrum of an original audio fragment is indicated at 22. The line 24 indicates the masked threshold for the signal calculated in a conventional manner from the spectrum 22.

MPEG-1 Layer I uses uniform symmetric mid-tread quantizers. If the input range of the quantizer is [−1,+1], then the step size A is the difference between two successive quantization levels and is given by:

$$Δ = \frac{2}{M - 1}$$

where M is the number of quantization levels used.

Generally, if the input signal is within the quantizer-input range and if M is large enough, it can be shown for a very large class of signals that the quantization error ε is approximately uniformly distributed having a variance of:

$${σ}_{ɛ}^{2} = \frac{{Δ}^{2}}{12}$$

For each frame of an audio fragment and for every sub-band, a group of 12 sub-band samples are first normalized to [−1,+1] resulting in 32 scale factors scfᵢ, one for each sub-band i. The energy of the noise levels for each sub-band i can now be estimated as:

$${σ}_{ɛ , i}^{2} = \frac{{Δ}^{2}}{12} \cdot {scf}_{i}^{2} \qquad Equation 1$$

This can be calculated for left and right channels and for all sub-bands. Thus, the noise levels for the fragment 22 if encoded in say an MPEG-1 Layer I encoder are indicated by the line 26. It can be seen that for the frequency ranges 28, 28′ and 28″ these noise levels exceed the masking threshold 24 and so it is assumed that some distortion may be audible even in the originally encoded audio fragment.

However, when post-processing such lossy-encoded audio-fragments, the post-processed quantization noise may further exceed the masking threshold of the post-processed fragment. As can be seen from the range 30 in FIG. 3(b), the noise level indicated by the line 26′ exceeds the masking threshold 24′ of the post-processed signal indicated by the line 22′ across a large frequency range and by a significant amount. Thus, FIG. 3(b) shows a significant rise in audible noise levels—compared to that of the coded fragment of FIG. 3(a)—between approximately [5,15] Bark which is approximately equal to [500,5000] Hz.

As mentioned previously, the original fragment is assumed not to be available in the detection process. Therefore, the actual masked thresholds and quantization noise levels of the coded and post-processed fragments are not available. However, these two quantities can be estimated from the bit-stream of the coded fragment (AS).

Turning now to the estimation of the masking threshold 24′ and the noise level 26′. In one variation of the first embodiment, a psycho-acoustic modeling component 20 generates an estimate for the masking threshold \hat{M}t for each frame from a post-processed channel 16. In the case of Incredible Sound post-processing, most of the processing affects the difference channel and so the amount of energy in the difference channel determines the amount of audible quantization noise after post-processing stereo-encoded fragments. Thus, the PCM data for each fragment of the difference channel is Fourier transformed by the psycho-acoustic modeling component 20 to provide a frequency spectrum for the post-processed fragment of the type shown by the line 22′ in FIG. 3(b). The estimate of the masking threshold \hat{M}t indicated by the line 24′ is then calculated from the spectrum 22′ in a conventional manner and provided to the detector 17.

An estimate of the noise level \hat{σ}_{ε}² for the post-processed fragment is derived in the detector 17 by first estimating the noise levels for the original fragment from the encoded bitstream (AS) using the quantization level information provided in the bitstream and Equation 1. Then, knowing the type of post-processing to be performed on the decoded signal, the detector 17 can perform the same post-processing on the estimated noise levels for the original fragment to provide the estimate of the noise level for the post-processed fragment \hat{σ}_{ε}².

The detector 17 then provides a measure of the amount of distortion D in the post-processed signal by integrating the estimated amount noise level 26′ in the post-processed signal exceeding the masking threshold 24′ for those frequencies for which quantization noise is audible on a frame-by-frame basis, i.e. the distortion measurement D is equal to:

$$D = {\sum }_{i = 1}^{5} {D}_{i}^{n} , {D}_{i =} \{ \begin{matrix}( {\hat{σ}}_{ɛ , i}^{2} - {\hat{M}}_{t , i} ) [ dB SPL ] , & if {\hat{( σ}}_{ɛ , i}^{2} - {\hat{M}}_{t , i} ) > 0 , \\ 0 , & otherwise\end{matrix}$$

where i is the sub-band number and n a penalize-index. The higher n, the more the distortion is penalized. For a sampling frequency of 48 kHz, range i=[1,5] is equal to [750,4500] Hz which is approximately the range where quantization noise is audible after post-processing. Then, on the basis of the distortion measurement D, the regulator 18 can then decide to take action against audible quantization noise.

An improved distortion measurement would, for example, also examine the durations of noise exceeding the masked threshold. The longer these durations, the more likely that quantization noise will become audible. This however is more complex than the simple distortion measurement D above.

It will be seen that using this first variation of the first embodiment, the regulator 18 will tend to allow audible distortion to occur before taking corrective action. In such cases, the system would need to have a desired level of post-processing so that if the level of post-processing is dropped for a particular frame or fragment, it can be incrementally increased thereafter towards the target value until a lessening correction is required again.

In a second variation of the preferred embodiment, FIG. 4, a variant of the psycho-acoustic modeling component 20′ draws the signal energy level data from the bitstream AS. As in the first variation in relation to noise, knowing the type of post-processing to be performed on the decoded signal, the component 20′ can perform the same processing on the original fragment to provide a frequency spectrum estimate of the post-processed signal as indicated by the line 22′ in FIG. 3(b). The masking threshold 24′ can then be calculated for this estimated signal and this can be passed to the detector 17 as before to enable the detector 17 to generate an estimate of the distortion D to be produced with the current level of post-processing. The detector 17 may then pass this distortion measurement D to the regulator 18 which can reduce the level of post-processing to be performed on the fragment for which the distortion estimate has been made. For example, for Incredible Sound post-processing the factor a is lowered for high values of D.

In the first embodiment, it is assumed that the bit-stream of the coded fragment is available and that the type of post-processing technique is known. However, in a second embodiment of the invention, FIG. 5, only the decoded audio channels 14 are available and so no decoder 10 is employed. In S. Moehrs, Jurgen Herre and Ralf Geiger, “Analyzing decompressed audio with the “Inverse Decoder”—towards an operative algorithm”, Convention Paper 5576 of the 112th Convention of the AES, 2002 May 10-13, Munich, and J. Herre and M. Schug, “Analysis of decompressed audio—The inverse decoder”, Convention Paper 5256 of the 109th AES Convention, Los Angeles, 2000 an inverse decoder 10′ is described. This enables the quantization levels for a fragment to be detected from the PCM domain signal. Thus, in the second embodiment, the inverse decoder 10′ provides this information to a variation of the detector 17′. The detector 17′ first estimates the noise levels for the original fragment and then processes these as before to provide an estimate of the noise levels in the post-processed fragment. In FIG. 5, the psycho-acoustic modeling component 20 draws its data from the post-processed channels 16 as in FIG. 1 to generate the masking threshold for the fragment which it provides to the detector 17′. Using this masking threshold and the noise levels, the detector can generate the distortion measure D as before.

It will be seen from the description above that in the preferred embodiments, unwanted artefacts are prevented from becoming audible in the output channels 16 while the audio bitstream AS is being decoded and post-processed in real-time.

In the preferred embodiments, the amount of post-processing applied is lessened or even completely disabled by the regulator 18. This is generally applicable to all post-processing techniques that add a certain amount of the processed signal to a certain amount of the original signal.

Another example of the regulation of post-processing independent of the use of noise levels or a masking threshold is to determine a as a function ƒ((Lᵢ−Rᵢ)/d) where ƒ( ) is some monotonic function varying between 0 and 1 for the argument of ƒ( ) varying from 0 to a maximum and d=Δ*scfᵢ. The means that if the difference between a left and right channel sub-band signal is small, it is preferable not to boost the signal too much.

In the preferred embodiments, the channels 14 and 16 are described as stereo channels. However, it will be seen that the invention is also applicable to more than two channels and also that the invention is not restricted to the number of channels 14 and 16 being the same.

In the preferred embodiments, the regulator 18 controls the post-processor 12 with a single parameter α. It will be seen that the invention is extendible to controlling many parameters of the post-processor. For example, in the case of the preferred embodiments, a vector of αᵢ could be used to control the post-processing of each sub-band i.

In the preferred embodiments, it is assumed that the detector 17, 17′ can estimate the post-processing carried out by the processor 12, as indicated by the line joining the components. The invention is therefore not restricted to estimating the effect of post-processing by a strictly defined process such as Incredible Sound. For example, the complete path from the decoder output channels 14 to a human ear including for example, amplifiers, loudspeakers and headphones can be modeled as a post-processor signal path. In the case of the preferred embodiments, this model can be applied to the calculated noise levels and/or masking thresholds to determine the degree to which the complete post-processing signal path makes quantization noise audible. Where the noise becomes excessively audible, the regulator can control some aspect of the post-processing signal path to reduce this noise, for example, by lowering the output volume of a loudspeaker slightly or adjusting the equalization of an amplifier.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. An audio system comprising:
a post-processor arranged to alter successive fragments of a decoded audio signal to provide successive fragments of post-processed audio signal;
a distortion detector for determining a degree to which quantization noise introduced in encoding said successive fragments of audio signal becomes audible due to said post-processing; and
a regulator arranged to control said post-processor according to said degree.

2. An audio system as claimed in claim 1 further comprising:
a masking threshold generator arranged to provide an estimate of a masking threshold for said successive fragments of post-processed audio signal;
a noise level detector arranged to provide an estimate of a noise level for said successive fragments of said post-processed audio signal;
and wherein said distortion detector determines said degree according to the degree to which said noise level exceeds said masking threshold for successive fragments of said post-processed audio signal.

3. An audio system as claimed in claim 2 further comprising a decoder arranged to read an audio stream and to produce said successive fragments of audio signal.

4. An audio system as claimed in claim 3 wherein said decoder produces stereo-encoded successive pairs of fragments of audio signal and said post-processor applies stereo-widening to said successive pairs of fragments of audio signal.

5. An audio system as claimed in claim 2 wherein said masking threshold generator comprises a psycho-acoustic modeling component arranged to transform said successive fragments of post-processed audio signal into the frequency domain; and to derive said masking threshold therefrom.

6. An audio system as claimed in claim 2 wherein said masking threshold generator comprises a psycho-acoustic modeling component arranged to read said audio stream and to produce successive fragments of audio signal; to apply similar post-processing to said successive fragments of audio signal as said post-processor; to transform said successive post-processed fragments of audio signal into the frequency domain; and to derive said masking threshold from said post-processed signal.

7. An audio system as claimed in claim 2 further comprising an inverse decoder arranged to read said successive fragments of a decoded audio signal and to provide therefrom indications of quantization levels employed in the encoding of an audio stream from which said audio signal is decoded.

8. An audio system as claimed in claim 3 in which said noise level detector is arranged to derive from said audio stream quantization levels employed in the encoding of an audio stream.

9. An audio system as claimed in claim 7 in which said noise level detector is arranged to derive from said quantization levels a distribution of noise level in the frequency domain for said successive fragments of a decoded audio signal, and to apply similar post-processing to said successive distributions of noise level as said post-processor to provide successive estimates of noise level for said successive fragments of said post-processed audio signal.

10. A method of processing an audio stream comprising the steps of:
post-processing successive fragments of a decoded audio signal to provide successive fragments of post-processed audio signal;
detecting a degree to which quantization noise introduced in encoding said successive fragments of audio signal becomes audible due to said post-processing; and
regulating said post-processing step according to said degree.
